(19) United States
(12) Patent Application Publication
(10) Pub. No.: US 2008/0040187 A1
(43) Pub. Date: Feb. 14, 2008

(54) SYSTEM TO RELAY MEETING ACTIVITY IN ELECTRONIC CALENDAR APPLICATIONS AND SCHEDULE ENFORCEMENT AGENT FOR ELECTRONIC MEETINGS

(75) Inventors: Theodore Robert Carraher, Durham, NC (US); Gabriel Aaron Cohen, Durham, NC (US); Jonathan Gellin, Raleigh, NC (US); Ruthie D. Lyle, Durham, NC (US)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/463,771

(22) Filed: Aug. 10, 2006

(51) Int. Cl. G06F 9/46

(52) U.S. Cl. 705/9

(57) ABSTRACT

An invention is disclosed for a computerized system for relaying meeting activity in electronic calendar applications, which allows a meeting participant to automatically obtain desired information about activity taking place in a scheduled meeting or presentation to allow that participant to determine whether he or she should attend. The invention also integrates electronic meeting software scheduling and coordination functions to provide a dynamic “schedule enforcement agent” for conducting meetings involving use of electronic data transmission technology (“emeetings”).

### TECHNICAL FIELD

This invention relates to a computerized system for relaying meeting activity in electronic calendar applications; and also to integration of electronic meeting software scheduling and coordination functions for conducting meetings involving use of electronic data transmission technology (“emeetings”).

### BACKGROUND

Electronic meetings (or “emeetings”) are often used for enabling a distributed group of individuals to participate in various types of multimedia collaboration involving video, voice, graphics and/or other types of electronic data transmission, to be used in demonstrations and other types of presentations. Commonly, emeetings can be scheduled to cover multiple topics, often with multiple presenters. Such meetings are typically scheduled in an electronic calendar entry with a single continuous reserved block of time for conducting all of the presentations given during the entire meeting. Problems tend to arise when several control authorization(s) (providing permission for a participant to initiate or supervise or resume a given electronic data transmission) must be transferred amongst different participants multiple times in a single emeeting, in the case when any meeting participant holding or requiring such control is absent or not in electronic contact with the other participants (i.e., “off-line”) or is occupied at the time when transfer is required.

Also, it is not uncommon for a meeting or presentation to extend beyond (or “overrun”) its originally-assigned time period or slot because of busy participant schedules and for other reasons. Under such circumstances, a participant must often decide if joining the meeting or presentation at such a time is necessary, worthwhile or even possible, particularly if subsequent meetings (or other commitments) are in place; and if the participant is not already in attendance at the meeting, there is no way to determine if the meeting is still in progress or not. Current computerized meeting applications require the participant to manually acquire information to make this determination, such as going to the physical location of the meeting or locating a telephone to call into the meeting and inquire as to whether it is still in progress (and if so, whether the participant should attend). If this is done too late, the participant often finds that the meeting has already been adjourned or that the need for his or her attendance has been superseded, and such a late interruption often disrupts the flow of the meeting.

Additional problems occur when a single presenter uses more time than originally allotted for completing a given presentation, which may lead to another presenter being given less allotted time or being required to forego a presentation, or alternately requiring a portion (or the remainder) of the meeting to be conducted after its scheduled completion time or at a later date. Alternately, a presenter can use less than his or her allotted time, which can result in unused meeting time if the schedule is not adjusted to accelerate the timing of later presentation(s). Typically, all of these problems are addressed using technology such as instant messaging (“IM”) or emails, which can be difficult to coordinate in managing the meeting as the number of participants grows.

The solutions for such problems described in U.S. Pat. Nos. 7,007,235 & 6,968,248 & 6,801,819; and in “An Open Architecture for Next-Generation Telecommunication Services” by Gregory W. Bond et al.; and in “Computer-Mediated Communication in Collaborative Educational Settings” by Ursula Wolz et al.; and in “Hyperactive: Extending an Open Hypermedia Architecture to Support Agency” by J. Alfredo Sanchez et al. (the teachings of all of which are incorporated by reference as if fully set forth herein) do not incorporate the combination of features provided by this invention.

### SUMMARY OF THE INVENTION

This invention discloses a computerized system for relaying meeting activity in electronic calendar applications, which allows a meeting participant to automatically obtain desired information about activity taking place in a scheduled meeting or presentation (including whether or not it is still in progress) to allow that participant to determine whether he or she should attend. The status information needed to make this determination is gathered by an electronic calendar software scheduling application and is preferably made available to a meeting participant through a computer graphical user (“GUI”) interface; and it allows the participant to determine whether to join the meeting or presentation after it has already started, and it also allows the participant to inquire whether the meeting has or will “overrun” its allotted time (i.e., remain in progress beyond the designated time slot) and if so, whether his or her attendance is still required, and what other information is available regarding the meeting if the participant is not already in attendance. Such data can be automatically obtained from the electronic calendar and/or other associated systems and combined (together with updates from the meeting participants) in various ways to allow the electronic calendar to display the most up-to-date and pertinent meeting activity information.

The invention also integrates electronic meeting software scheduling and coordination functions to provide a dynamic “schedule enforcement agent” for conducting meetings involving use of electronic (including computer and/or telecommunications network) data transmission technology (“emeetings”). The schedule enforcement agent is responsible for automatically resolving user electronic connectivity problems, as well as problems arising from absent meeting participants or from over or under-utilization of allotted presentation time by participants. Specifically, the invention discloses an electronic meeting software scheduling coordination agent that contains features for automatically prompting a transfer in connection control when the presentation time for a participant has expired in the meeting agenda. Additionally, the schedule enforcement agent contains features that allow users to interact with it (and with each other) to dynamically adjust scheduling of a multipart collaborative meeting session; by providing functions that permit users to interactively negotiate rescheduling of meeting presentation times, dates and/or sequences as the need arises and then alerting users of resulting changes to the presentation and/or meeting schedule, and that periodically or continually notify a meeting participant of the amount of time remaining for a presentation in order to allow the presenter to request more time for its completion (to be allotted by the schedule enforcement agent if available). These features can be organized into a user-input driven (or “workflow” structured) software system which dynamically responds to such conditions during the course of a meeting, and it can include features such as instant messaging (“IM”) and/or electronic mail (“email”) to provide notifications and permit meeting participant interaction during use of the system.

It is therefore an object of the present invention to overcome the disadvantages of the prior art by providing a computerized system for relaying meeting activity in electronic calendar applications, which allows a meeting participant to automatically obtain desired information about a scheduled meeting or presentation to allow that participant to determine whether he or she should attend, through use of data automatically obtained from an electronic calendar software scheduling application and/or other associated systems that is combined (together with updates from the meeting participants) to allow the electronic calendar to display the most up-to-date and pertinent meeting activity information that is made available to a meeting participant through a computer user interface.

It is another object of the present invention to overcome the disadvantages of the prior art by providing a computerized system for relaying meeting activity in electronic calendar applications, which allows a meeting participant to automatically obtain desired status information about a scheduled meeting or presentation that is gathered by an electronic calendar software scheduling application, in order to allow the participant to determine whether the meeting or presentation is still in progress and whether to join it after it has already started, and to allow the participant to inquire whether the meeting or presentation has or will remain in progress beyond the designated time period and if so whether his or her attendance is still required, and what other information is available regarding the meeting.

It is another object of the present invention to overcome the disadvantages of the prior art by providing a method and system for integrating electronic meeting software scheduling and coordination functions to provide a dynamic “schedule enforcement agent” for automatically resolving user electronic connectivity problems (as well as problems arising from absent meeting participants or from over or under-utilization of allotted presentation time) in conducting meetings involving use of electronic (including computer and/or telecommunications network) data transmission technology (“emeetings”).

It is another object of the present invention to overcome the disadvantages of the prior art by providing an electronic meeting software scheduling enforcement and coordination agent that contains features for automatically prompting a transfer in connection control when the presentation time for a participant has expired in the meeting agenda.

It is another object of the present invention to overcome the disadvantages of the prior art by providing an electronic meeting software scheduling coordination agent that contains features for allowing users to interact with it (and with each other) to dynamically adjust scheduling of a multipart collaborative meeting session, by providing functions that permit users to negotiate rescheduling of meeting presentation times, dates and/or sequences as the need arises and then alerting users of resulting changes to the presentation and/or meeting schedule, and that periodically or continually notify a meeting participant of the amount of time remaining for a presentation in order to allow the presenter to request more time for its completion (to be allotted by the schedule enforcement agent if available).

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 is a diagram illustrating use of an electronic calendar computer software scheduling application with a system to relay meeting activity and a schedule enforcement agent for electronic meetings.

FIG. 2 is a diagram illustrating use of a system for relaying meeting activity in an electronic calendar application.

### DETAILED DESCRIPTION OF THE PREFERRED EMBODIMENTS

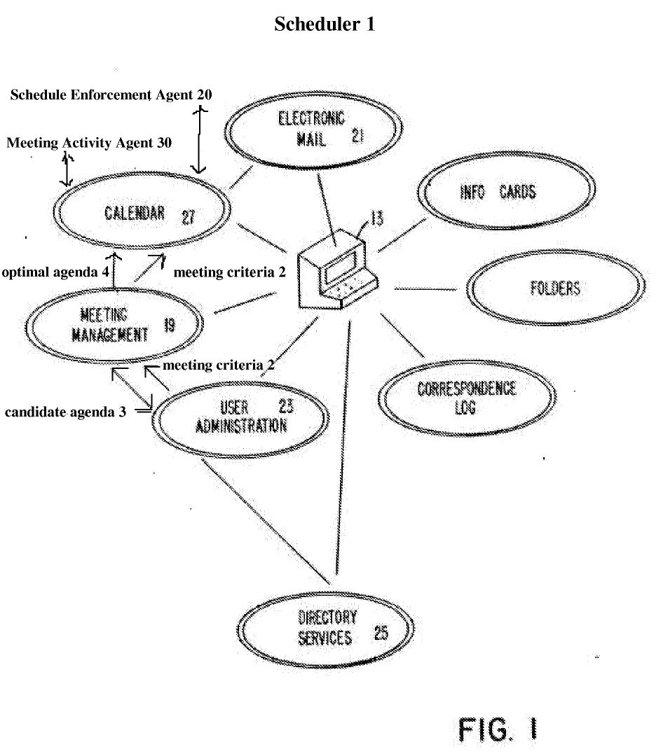

FIG. 1 is a diagram illustrating use of the invention in conjunction with a computer software application which automatically schedules and manages agendas for presentation-style meetings, such as that disclosed in U.S. patent application Ser. No. 11/309048 (incorporated by reference as if fully set forth herein). The scheduling application 1 allows a user 23 to maintain an electronic calendar 27 in order to coordinate his or her individual daily schedule using a personal computer workstation 13 or other type of computerized device. The electronic calendar 27 for each user 23 can be accessed by other users on a computer network (such as a local area network (“LAN”) or a wide area network (“WAN”) or the Internet) through a network directory 25. The scheduling application 1 allows a user 23 (such as a meeting scheduler) to schedule meetings among other users maintaining individual electronic calendars 27 on the computer network. Each individual electronic calendar 27 can accept criteria for meeting events 2 to be formed into a schedule or agenda 4; such as a meeting or presentation start date/time and/or stop time or duration on particular day(s); details describing the topic(s), location(s) and/or attendee(s) of the meeting; and a listing of the associated resources used to conduct the meeting, i.e., identification of teleconference/videoconference, computer and/or other equipment to be used in conducting a local or remote (including an electronic) meeting (“emeeting”). The meeting event criteria 2 arises from information provided by a user 23 that may be input manually or retrieved from other records (such as electronic mail or notes or files or correspondence).

The “schedule enforcement agent” 20 can be configured to operate in conjunction with such an electronic calendar software scheduling application 1 by executing rules to provide the functions described herein, and it can be implemented as a resident computer program on a networked or internet (web-based) host server that is utilized for running meeting scheduling and coordination software associated with an electronic calendar application, such as Microsoft Outlook®, Novell GroupWise®, Oracle® Calendar or Sun Java System® Calendar Server, etc.

The meeting agenda 4 generated by the electronic calendar scheduling application 1 can be used by the schedule enforcement agent 20 to automatically grant a transfer in connection control when the presentation time for a participant has expired in the meeting agenda. This feature can be made operative to enable such a transfer even if the current or previous presenter is not available to initiate the transfer in control, or if no meeting moderator is present to authorize this change. Alternately, the schedule enforcement agent 20 can be configured to permit connection control transfer authority to be given to specified backups for the presenter or moderator. Furthermore, the schedule enforcement agent 20 can itself act as a moderator by automatically processing requests for connection control transfer authority, which can be granted based upon use of data from the meeting agenda 4 generated by the electronic calendar scheduling application 1 (such as profile information 2 identifying meeting attendees to whom connection control can be deferred) or on a vote by meeting participants.

The schedule enforcement agent 20 can be configured to privately display the amount of time remaining for a presentation to the active presenter, for the purpose of prompting that presenter to request more time to complete the presentation (or to yield time for allowing commencement of the next presentation); and it can publicly display the extent to which the meeting is running ahead of or behind its allotted time schedule. If a presentation is running behind schedule, the schedule enforcement agent can prompt the presenter to consider finishing the presentation before its completion; or in the event that a presenter requests more time to complete a presentation, the schedule enforcement agent can prompt later presenters to yield an equal amount of time out of their own scheduled presentations to preserve the overall meeting length. Alternately, if no other presenter is able to yield time from a later presentation, the schedule enforcement agent 20 can dynamically attempt to allot more time on the personal calendar 27 of each participant (and/or to reserve more allotted time for use of meeting rooms) to allow a portion (or the remainder) of the meeting to continue after its scheduled completion time; or it can attempt to reschedule the remainder of the meeting for a later date if one or more of the participants and/or a meeting room is not available. If extra unused time periods (or low priority agenda items that can be eliminated) are designated in the meeting schedule, the schedule enforcement agent can automatically re-allot this as “free time” which can be added to a presentation by request.

The schedule enforcement agent 20 can also be configured to dynamically allow presenters to negotiate a switch in presentation time slots (or accomplish other rescheduling functions) during the course of a meeting and to notify other parties of the change. Further, the schedule enforcement agent can be configured to recognize whether the amount of additional time needed for completion of a presentation falls within specified threshold(s) requiring that certain rescheduling action(s) be taken instead of others. The schedule enforcement agent can be configured to automatically notify participants of any meeting or presentation schedule changes via use of emeeting IM or email; and it can take similar actions to free up resources if a meeting is running ahead of (rather than behind) schedule.

As shown in FIGS. 1 & 2, information associated with a meeting event agenda 4 gathered by the electronic calendar scheduling application 1 can automatically provide relevant information to a “meeting activity agent” 30, in order to allow a meeting participant to determine whether or not he or she should attend a scheduled meeting or presentation. For example, an agenda 4 associated with an electronic meeting (“emeeting”) event 2 could be interrogated for information about activity taking place in the meeting, such as the present location(s) of the meeting as well as a current list of participants, etc. An internet website and/or a teleconference/videoconference provider service can also be queried to determine if an online or teleconference or videoconference is still active (and if so, which parties were and are still participating in the conference); and a “smart room” can be queried to determine if anyone is still present at the physical location(s) of the meeting. The meeting chairperson (or other person(s) responsible for conducting the meeting) can also initiate updates to such “meeting event activity” information 31 at intervals throughout the meeting.

In order to enable use of such a meeting activity agent 30, the features of the electronic calendar scheduling application 1 can be extended to include meeting activity information such as that described above. In so doing, a general set of meeting activity fields 31 can be defined in the user interface 10 of the electronic calendar 27 to answer questions (and provide information) including but not limited to: whether the meeting or presentation is still in progress; the topics in the agenda that have been (or are currently being) covered in the meeting; the participants that have been or are currently in attendance at the meeting; whether the meeting chairperson has listed a particular participant as a required attendee; whether the status of any participant has changed from required to optional attendee; whether the meeting has extended beyond its prescribed time period (or if not, is it expected to run overtime) and if so, whether the objective is still the same; any updated objective(s) of the meeting; any updated meeting location(s) and/or any updated resource information for the meeting. Moreover, a policy (or set of rules) can be defined to specify the particular information that should be made available for a meeting, and to indicate the extent (or amount) of information that should be made available based on the identity of the person requesting the information. For example, required meeting participants might be provided access to all meeting activity information, while optional attendees might have access to some necessary amount of this information, whereas others might obtain access to a smaller amount of meeting information containing less specific details.

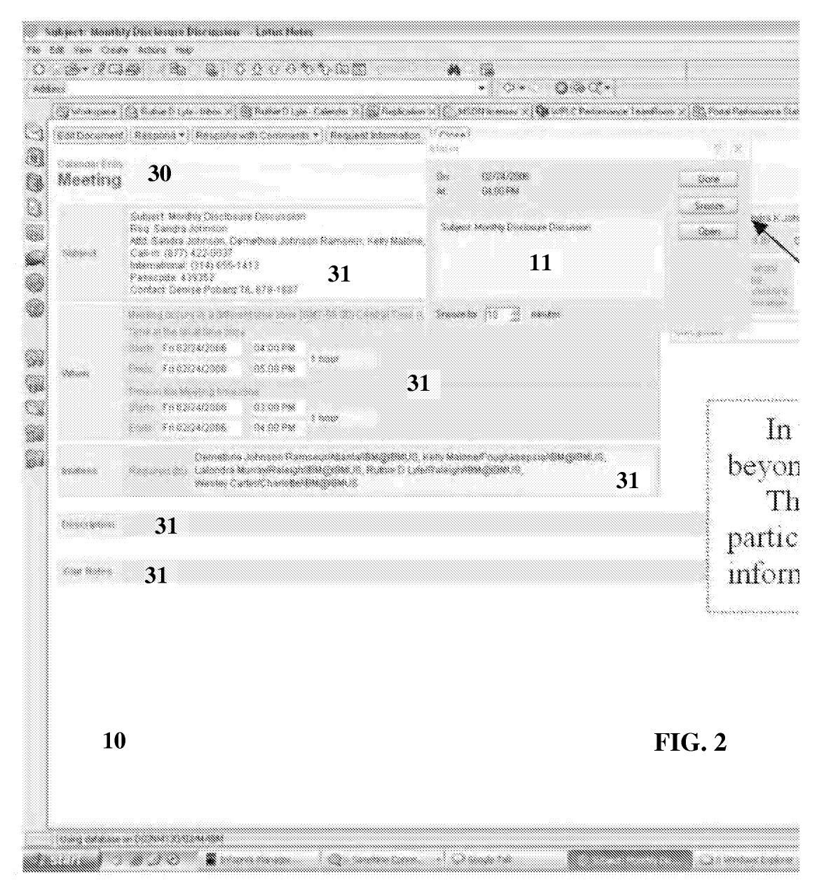

FIG. 2 shows an example GUI view that a meeting participant would see in the electronic calendar application associated with Lotus Notes. (In this example it is 30 minutes past the scheduled start of a meeting.) Several different types of GUI interfaces 10 can be designed to enable the electronic calendar scheduling application 1 to relay meeting activity information 31 to a participant. This interface can include (but not be limited to) features allowing the electronic calendar GUI 10 to “self update” without user action, such as updating the background color around the “meeting reminder pop-up window” 11 to provide current status; i.e., a “red” background can indicate that the meeting is finished, whereas “green” can indicate that the meeting is still in progress, and “yellow” can indicate that the meeting is (“wrapping up”) and is thus close to conclusion. Also, this meeting reminder pop-up window 11 can be configured to “flash” (on and off) to alert a participant that his or her attendance is required and not optional; and an icon can be used to indicate that the meeting it has overrun its time slot and is still in progress. Alternately, the electronic calendar GUI 10 can be configured to update by performance of a user action, such as a mouse “right click” and/or “hover over” action while the cursor is located on the meeting reminder pop-up window 11 to enable a return of the meeting activity information 31 to a participant.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computerized system or network for relaying meeting activity comprised of at least the following software components:
(a). an electronic calendar component configured for scheduling and managing data contained in at least one agenda for a meeting involving one or more presentations;
(b). a meeting activity component configured to process meeting information through use of data automatically obtained from the electronic calendar component that is combined with meeting updates; and
(c). a computer user interface configured for displaying updated meeting activity information through use of the electronic calendar.

2. The computerized system or network for relaying meeting activity of claim 1 wherein meeting activity information is comprised of:
(a). information from a meeting agenda;
(b). information from an internet website;
(c). information from a teleconference or videoconference provider service; or
(d). information from a meeting location.

3. The computerized system or network for relaying meeting activity of claim 2 wherein the meeting activity information is provided to a meeting participant for determining whether:
(a). the meeting or a presentation is currently in progress;
(b). the meeting or a presentation remains in progress beyond the designated time period;
(c). attendance of the participant is required; or
(d). any other information available regarding the meeting or a presentation.

4. The computerized system or network for relaying meeting activity of claim 3 wherein meeting activity information is further selected from a group comprised of:
(a). topics in a meeting agenda;
(b). meeting participants;
(c). required meeting attendees;
(d). optional meeting attendees;
(e). meeting objectives;
(f). meeting locations; or
(g). resources used for the meeting.

5. The computerized system or network for relaying meeting activity of claim 1 wherein the meeting activity component is configured to execute rules defined to specify:
(a). the types of meeting activity information made available; or
(b). the amount of meeting activity information made available; wherein the specification is determined by the identity of the system user requesting the information.

6. The computerized system or network for relaying meeting activity of claim 1 wherein the computer user interface is configured to update without user action.

7. The computerized system or network for relaying meeting activity of claim 1 wherein the computer user interface is configured to update by performance of a user action.

8. A computerized system comprised of at least the following software components configured for integrating scheduling and coordination in conducting meetings involving electronic data transmission over a computer or telecommunications system or network:
(a). an electronic calendar component configured for scheduling and managing data contained in at least one agenda for a meeting involving one or more presentations; and
(b). a schedule enforcement component configured for dynamically using data from a meeting agenda to automatically resolve:
(i). electronic connection problems between system users; or
(ii). scheduling problems arising from absent meeting participants or from over-utilization or under-utilization of allotted presentation time.

9. The system of claim 8 wherein the schedule enforcement component automatically prompts a transfer in electronic connection control when the presentation time for a participant has expired in the meeting agenda.

10. The system of claim 8 wherein the schedule enforcement component is configured for allowing system users to interact with each other to dynamically adjust scheduling of a meeting by executing rules to:
(a). permit users to negotiate rescheduling of presentation times or dates or sequences;
(b). alert system users of changes to a presentation or meeting schedule;
(c). notify a meeting participant of the amount of time remaining for a presentation;
(d). permit a meeting participant to request more time for completion of a presentation; or
(e). allot more time for completion of a presentation.

11. The system of claim 10 wherein the schedule enforcement component is configured for recognizing whether the amount of additional time needed for completion of a presentation falls within specified thresholds requiring that certain rescheduling actions be taken instead of others.

12. The system of claim 10 wherein the schedule enforcement component is configured for automatically notifying participants of any meeting or presentation schedule changes through use of instant messaging or electronic mail.

13. A method of using a computerized system comprised of at least the following software components configured for integrating scheduling and coordination in conducting meetings involving electronic data transmission over a computer or telecommunications system or network comprised of the following steps:
(a). configuring an electronic calendar component for scheduling and managing data contained in at least one agenda for a meeting involving one or more presentations; and
(b). configuring a schedule enforcement component for dynamically using data from a meeting agenda to automatically resolve:
(i). electronic connection problems between system users; or
(ii). scheduling problems arising from absent meeting participants or from over-utilization or under-utilization of allotted presentation time.

14. The method of claim 13 wherein the schedule enforcement component automatically prompts a transfer in electronic connection control when the presentation time for a participant has expired in the meeting agenda.

15. The method of claim 13 wherein the schedule enforcement component is configured for allowing system users to interact with each other to dynamically adjust scheduling of a meeting by carrying out the following steps:
(a). permitting users to negotiate rescheduling of presentation times or dates or sequences;
(b). alerting system users of changes to a presentation or meeting schedule;
(c). notifying a meeting participant of the amount of time remaining for a presentation;
(d). permitting a meeting participant to request more time for completion of a presentation; or
(e). allotting more time for completion of a presentation.
